(19) United States
(12) Patent Application Publication
(10) Pub. No.: US 2026/0017759 A1
(43) Pub. Date: Jan. 15, 2026

(54) SYSTEMS AND METHODS FOR IMPROVING VISUALIZATION OF PROCESSED IMAGES

(71) Applicant: PAIGE.AI, Inc., New York, NY (US)

(72) Inventor: Ali Mehmet ALTUNDAG, ’S-Gravenhage (NL)

(21) Appl. No.: 19/263,746

(22) Filed: Jul. 9, 2025

Related U.S. Application Data
(60) Provisional application No. 63/668,824, filed on Jul. 9, 2024.

(51) Int. Cl. G06T 5/50; G06T 11/20

(52) U.S. Cl. CPC G06T 5/50; G06T 11/23; G06T 2207/20216; G06T 2207/30024; G06T 2210/41

(57) ABSTRACT

A method for improving visualization of processed images which may include: determining a plurality of annotated points associated with a selected image, determining a default visualization of each annotated point of the plurality of annotated points in the selected image, determining a display image by determining a blended visualization for each pixel of the display image based on the plurality of annotated points of the selected image corresponding to the pixel, and displaying the determined display image.

### CROSS REFERENCE TO RELATED APPLICATIONS

This application claims priority to U.S. Provisional Application No. 63/668,824, filed on July 9, 2024, the entire disclosure of which is hereby incorporated by reference in its entirety.

### TECHNICAL FIELD

Various embodiments of the present disclosure relate generally to improving visualization of processed images and, more particularly, to improving visualization of processed and annotated pathology slide images at varying magnification levels.

### BACKGROUND

Some types of image data, such as, for example, whole slide images (WSI) of tissue samples, may include annotations, including annotations of tissue type, gene expressions, foreground/background, malignancy, "good" cells versus "bad" cells, and/or other labels. The annotations may be applied, for example, to individual cells shown in the WSI or to tiles/subregions of the WSI. Such annotations may, in some applications, be visualized as points, including points with differing colors according to the type of label indicated by the annotation. These color-coded points can provide information about the underlying tissue structures and cellular characteristics that may be relevant for diagnostic or research purposes.

At high magnifications, each annotation or point may be individually visible, allowing a viewer to discern each annotated point of the WSI. The visibility of individual points at high magnification enables detailed examination of specific regions and cells within the tissue sample. Users can identify patterns, distributions, and relationships between different types of annotations when viewing the WSI at these higher magnification levels. This detailed view supports precise analysis of cellular structures and their associated annotations.

However, at low magnifications, or as a user zooms out, it may become difficult to discern each point, and information of interest to the viewer about the tissue depicted in the WSI may be obscured and/or overly crowded. For some images at some magnifications, there may be more annotated points than pixels available to display the WSI. The density of annotations can create visual challenges when attempting to interpret the image at lower magnification levels. This limitation can restrict the utility of annotated WSIs when users may need to examine broader tissue regions while maintaining awareness of annotation distributions.

The present disclosure is directed to overcoming one or more of these above-referenced challenges. The techniques described herein address the visualization issues that occur when viewing annotated WSIs across different magnification levels.

The foregoing general description and the following detailed description are exemplary and explanatory only and are not restrictive of the disclosure. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the present disclosure, systems and methods are disclosed for improving visualization of processed images.

In one embodiment, a computer-implemented method is disclosed for improving visualization of processed images, the method including: determining a plurality of annotated points associated with a selected image, determining a default visualization of each annotated point of the plurality of annotated points in the selected image, determining a display image by determining a blended visualization for each pixel of the display image based on the plurality of annotated points of the selected image corresponding to the pixel, and outputting the determined display image.

In some aspects, the techniques described herein relate to a method, wherein the blended visualization is determined by steps including averaging the default visualizations of each annotated point of the plurality of annotated points corresponding to each pixel in the selected image; and computing and drawing contours around the default visualizations of the plurality of annotated points.

In some aspects, the techniques described herein relate to a method, wherein the selected image is a whole slide image (WSI), and wherein each annotated point among the plurality of annotated points comprises information about a region of the WSI, tissue depicted in the WSI, a cell depicted in the WSI, or a tile of the WSI.

In other aspects, the techniques described herein relate to a method, wherein the information of the annotated point comprises one or more of a type of tissue depicted, the type of tissue being one of cell tissue, foreground tissue, or background tissue, a characterization of a cell, the characterization being one or more of positive, negative, good, bad, cancer, or benign, or an attribute of tissue depicted, the attribute being one or more of a gene expression, an abnormality, or a morphology.

In some aspects, the techniques described herein relate to a method, wherein the default visualization associated with the plurality of annotated points may be determined by a look up table, an algorithmic process, or an artificial intelligence system.

In other aspects, the techniques described herein relate to a method, wherein the default visualizations associated with the plurality of annotated points corresponding to the pixel include visualizations of a first type and visualizations of a second type, and wherein the blended visualization of each pixel of the display image is determined based on a number or a percentage of annotations with visualizations of the second type being below a threshold. In further aspects, the techniques described herein relate to a method, wherein the blended visualization of each pixel of the display image is determined by a lookup table, an algorithmic blending, or a user-specified substitution.

In some aspects, the techniques described herein relate to a method wherein the default visualizations associated with the plurality of annotated points corresponding to the pixel include visualizations of a first type and visualizations of a second type, and wherein the blended visualization of each pixel of the display image is weighted based on a proportion of the visualizations of the first type and the visualizations of the second type.

In other aspects, the techniques described herein relate to a method, wherein the blended visualization of each pixel of the display image may be weighted based on a density of the visualizations associated with the annotations corresponding to the pixel.

In some aspects, the techniques described herein refer to a method, wherein the visualizations may be associated with the annotations corresponding to the pixel include visualizations of a first type, visualizations of a second type, and visualizations of a third type.

In accordance with another embodiment, a system is disclosed for improving visualization of processed images, the system including: a data storage device storing instructions for improving visualization of processed images in an electronic storage medium; and a processor configured to execute the instructions to perform operations including: determining a plurality of annotated points associated with a selected image, determining a default visualization of each annotated point of the plurality of annotated points in the selected image, determining a display image by determining a blended visualization for each pixel of the display image based on the plurality of annotated points of the selected image corresponding to the pixel, and displaying the determined display image.

In some aspects, the techniques described herein relate to a system, wherein the blended visualization may be determined by steps including averaging the default visualizations of each annotated point of the plurality of annotated points corresponding to each pixel in the selected image; and computing and drawing contours around the default visualizations of the plurality of annotated points.

In some aspects, the techniques described herein relate to a system, wherein the default visualizations may be associated with the plurality of annotated points corresponding to the pixel include visualizations of a first type and visualizations of a second type, and wherein the blended visualization of each pixel of the display image may be determined based on a number or a percentage of annotations with visualizations of the second type being below a threshold.

In other aspects, the techniques described herein refer to a system, wherein the blended visualization of each pixel of the display image may be determined by a lookup table, an algorithmic blending, or a user-specified substitution.

In some aspect, the techniques described herein refer to a system, wherein the blended visualization of each pixel of the display image may be weighted based on a density of the visualizations associated with the annotations corresponding to the pixel.

In accordance with another embodiment, a non-transitory machine-readable medium storing instructions that, when executed by the a computing system, causes the computing system to perform operations for improving visualization of processed images, the operations including: determining a plurality of annotated points associated with a selected image, determining a default visualization of each annotated point of the plurality of annotated points in the selected image, determining a display image by determining a blended visualization for each pixel of the display image based on the plurality of annotated points of the selected image corresponding to the pixel, and displaying the determined display image.

In some aspects, the techniques described herein relate to a non-transitory computer-readable medium, wherein the blended visualization may be determined by steps which may include averaging the default visualizations of each annotated point of the plurality of annotated points corresponding to each pixel in the selected image; and computing and drawing contours around the default visualizations of the plurality of annotated points.

In other aspects, the techniques described herein relate to a non-transitory computer-readable medium, wherein the visualizations associated with the annotations corresponding to the pixel may include visualizations of a first type and visualizations of a second type, and wherein the blended visualization of each pixel of the display image may be determined based on a number or a percentage of annotations with visualizations of the second type being below a threshold.

In some aspects, the techniques described herein relate to a non-transitory computer-readable medium, wherein the blended visualization of each pixel of the display image may be determined by a lookup table, an algorithmic blending, or a user- specified substitution.

In other aspects, the techniques described herein relate to a non-transitory computer-readable medium, wherein the blended visualization of each pixel of the display image may be weighted based on a density of the visualizations associated with the annotations corresponding to the pixel.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1depicts an exemplary system infrastructure for improving visualization of processed images, according to one or more embodiments.

FIG. 2depicts a flowchart of a method 200 of improving visualization of processed images, according to one or more embodiments.

FIG. 3A depicts a flowchart illustrating an exemplary process for blending visualizations of annotated points in processed images.

FIGS. 3B-3G depict the progression of image processing from the original annotated image to the final blended visualization, according to techniques discussed herein.

FIGS. 4A-4F depict exemplary image visualizations by a method of improving visualization of processed images, according to one or more embodiments.

FIG. 5depicts a flow diagram of a training system for machine learning models in digital pathology.

FIG. 6 depicts an exemplary computer device or system, in which embodiments of the present disclosure, or portions thereof, may be implemented. Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION

Various aspects of the present disclosure relate generally to computer- implemented techniques for image processing, such as WSIs obtained using medical imaging. Aspects disclosed herein may provide techniques configured for improving visualization of processed and annotated pathology slide images at varying magnification levels.

Techniques described in the current disclosure may utilize systems and methods described in US App. No. 17/014,532, filed September 8, 2020, US App. No.17/398,388, filed October 10, 2021, and US App No. 17/350,328, filed June 17, 2021, all of which are incorporated herein by reference.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

As used herein, the term "exemplary" is used in the sense of "example," rather than "ideal." Moreover, the terms "a" and "an" herein do not denote a limitation of quantity, but rather denote the presence of one or more of the referenced items.

The present disclosure provides for machine-learning and artificial intelligence-based techniques of image processing. The logistical and financial challenges and/or undesired results or errors associated with manual analysis of images may also be reduced. More specifically, techniques disclosed herein to generate a navigable three-dimensional image of a tissue sample may provide for faster, real- time, more accurate, and more efficient processing of image data and/or diagnosis pertaining to analysis of image data in comparison to conventional techniques. Techniques disclosed herein may further reduce the computational resources required for such processing by, for example, leveraging machine-learning training to reduce just-in-time processing loads.

As used herein, a "machine-learning model" generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of any machine-learning models, discussed in association with techniques presented herein, may include deployment of one or more machine-learning techniques, such as a transformer model, graph neural network (GNN), linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K- Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein may involve certain types of machine- learning and artificial intelligence, it should be understood that techniques according to this disclosure may be adapted to any suitable type of machine-learning and/or artificial intelligence. It should also be understood that the examples above are illustrative only. The techniques and technologies of this disclosure may be adapted to any suitable activity.

While various aspects relating to medical imaging and medical diagnostics (e.g., diagnosis of a medical condition based on medical imaging) are described in the present aspects as illustrative examples, the present aspects are not limited to such examples. For example, the present aspects can be implemented for other types of image processing.

Reference will now be made in detail to the exemplary embodiments of the present disclosure, examples of which are illustrated in the accompanying drawings. Wherever possible, the same reference numbers will be used throughout the drawings to refer to the same or like parts.

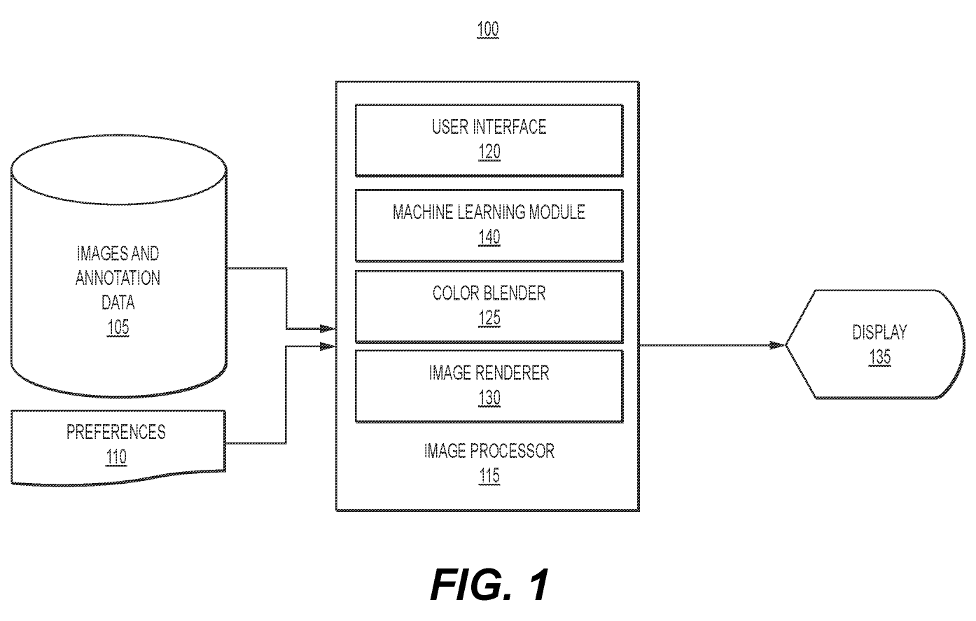

FIGS. 1, 2, 5, and 6 and the following discussion provide a general description of a suitable computing environment in which the present disclosure may be implemented. In one embodiment, any of the disclosed systems, methods, and/or graphical user interfaces may be executed by or implemented by a computing system consistent with or similar to that depicted in FIGS. 1, 5, and 6. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants ("PDAs")), wearable computers, all manner of cellular or mobile phones (including Voice over IP ("VoIP") phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms "computer," "server," and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, may be described as being performed exclusively on a single device, the present disclosure may also be practiced in distributed environments where functions or modules are shared among disparate processing devices, which are linked through a communications network, such as a Local Area Network ("LAN"), Wide Area Network ("WAN"), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non- transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

As discussed above, some types of images data, such as, for example, WSIs of tissue samples, may include annotations, including tissue type, gene expressions, foreground/background, malignancy, "good" cells versus "bad" cells, or other labels. Such annotations may be applied at differing scales. For example, an annotation may apply to a portion of an image, such as a background area or an area depicting a particular tissue type, to a cell depicted in the WSI, or to image tiles within the image of a cell. Such annotations may be provided by an expert user of an image annotation system, such as a pathologist viewing slide images of pathology specimens, by a group of users viewing and annotating an image collaboratively, or may be generated automatically, such as by an artificial intelligence or machine learning process.

The WSI and annotation data may originate from separate sources. The annotation data may be applied to the WSI as distinct overlays without modifying or embedding them in the WSI file. For example, a digital pathology platform may load raw WSIs without embedded annotations and subsequently apply computational models to generate annotations. These annotations can be rendered as overlays during the visualization process without modifying the underlying image file. This separation between image data and annotation data may provide flexibility in how the annotations are processed and displayed, allowing for different visualization techniques to be applied based on factors such as magnification level, annotation density, and user preferences. The system may maintain the original WSI data while dynamically generating and adjusting annotation visualizations according to the viewing context.

However, as the density of annotations increase, or at low magnifications of the WSI, it may become difficult to discern each annotated point, and information of interest to the viewer about the tissue depicted in the WSI may be obscured. For some images at some magnifications, there may be more annotated points than pixels available to display the WSI. Thus, viewing annotations of WSIs may be limited to high levels of magnification. This may prevent the viewer from understanding the contents of the WSI.

By implementing methods for blending and adapting the display of annotations based on magnification and point density, the present disclosure provides solutions that improve the interpretability of annotated images. These solutions can help maintain the contextual understanding of annotation distributions even when viewing WSIs at lower magnification levels.

As discussed in detail below, one or more embodiments of the present disclosure may address these issues through combining or blending the representations of multiple labeled points in an image as the viewing magnification level decreases. For example, annotated points may have one of two labels, such as two gene expressions, and the annotated points may each be assigned a color based on the labels. In one example, points with the first gene expression may be colored green and points with the second gene expression may be colored orange. At low magnification levels, a region of the displayed image including green and orange points may be rendered in a third color. Other modes of rendering annotated points, other than by color, such as though different symbols or patterns, may be employed. Such a process of combining or blending the representations of multiple labeled points in an image will be discussed in greater detail below.

An annotated point of an image may be associated with a particular color, symbol, or pattern at the time the annotation is applied to the image. That is, the label may have predetermined colors applied at the time of annotation or generation. Alternatively, the annotated point may be associated with a particular color, symbol, or pattern may be based on a predetermined association, such as by way of a lookup table, or a color, symbol, or pattern applied to an annotated point may be determined algorithmically at display time, such as based on a number of different labels are present in an images, or according to other criteria.

One or more embodiments of the present disclosure may provide systems and methods of improving visualization of processed images. As discussed below with respect to FIGS. 1-5, such systems and methods may include operations to receive a desired magnification level and selected portion of an image, determine the annotated points in the selected portion of the image, determine a display color for each annotated point, and/or determine a blended color for each portion of a display image based on the selected portion of the image and magnification level. These operations will be described in further detail below with respect to FIGS. 1-5.

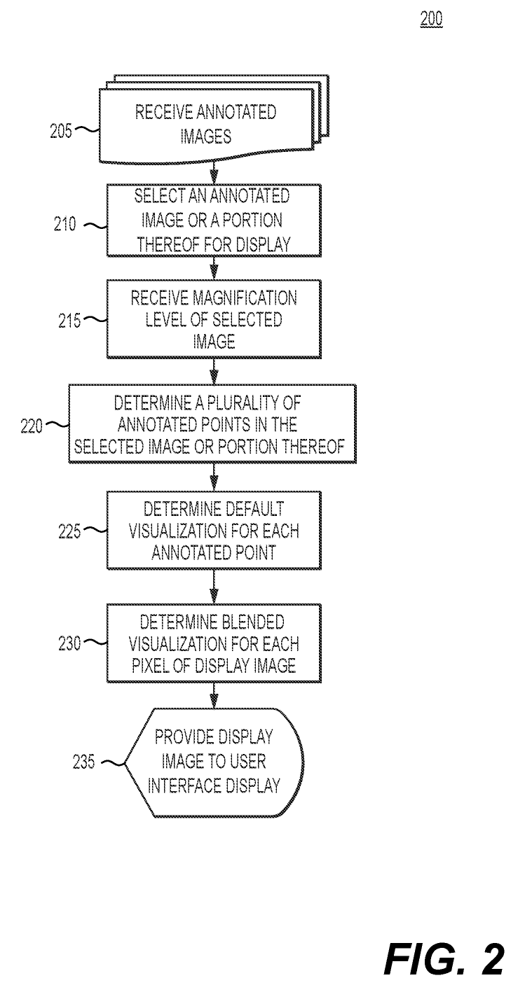

FIG. 1depicts an exemplary system 100 for improving visualization of processed images, according to one or more embodiments, and FIG. 2depicts a flowchart of a method 200 of improving visualization of processed images, according to one or more embodiments.

Annotations included with an annotated image, such as, for example a WSI among the images and annotation data 105, depicted in FIG. 1, may not include information for rendering the annotations with a visualization of the WSI. For example, it may be left to the system rendering the WSI for viewing, such as image processor 115, to determine colors, symbols, text, transparency, or patterns to be rendered with the WSI to indicate the presence of annotations. The system may determine visualization parameters based on the type of annotation, the content of the annotation, or metadata associated with the annotation. Image processor 115 may apply visualization rules that assign colors to different annotation types, such as assigning green to one gene expression and orange to another gene expression. The visualization parameters may be determined at the time of display rather than being stored with the annotation data. This approach allows the system to adapt the visualization based on display requirements, magnification levels, or user preferences without modifying the underlying annotation data. The terms "image processor", "image processing system", and "the system" may be used interchangeably in this disclosure.

As shown in FIG. 1, an image processor, such as image processor 115, may receive one or more annotated images, such as images and annotation data 105. For example, the images may be WSIs and the annotation data may be point coordinates, point labels, such as, for example, tissue type, gene expressions, foreground/background, malignancy, "good" cells versus "bad" cells, or other labels, and point visualization information, such as, for example, differing colors (e.g., RGBA color data), symbols, or patterns according to the type of label indicated by the annotation. Image processor 115 may provide a user interface, such as user interface 120, by which a user may, for example, select an image for viewing from among the one or more annotated images, select a portion of the selected image, select a magnification level for viewing the selected portion of the selected image, select options for controlling the visualization of the selected portion of the selected image. Image processor 115 may include a module, such as color blender 125 depicted in FIG. 1, for determining how annotated points in an image will be displayed. Details of this determination will be discussed in detail below.

Image processor 115 may include a module, such as image renderer 130 depicted in FIG. 1, for rendering an image and annotation-associated points for display to a user, such as according to the determination made by color blender 125. The image renderer 130 may implement various rendering techniques including rasterization, ray tracing, or hybrid approaches depending on the complexity of the visualization requirements. Image renderer 130 may process the blended visualization data from color blender 125 and apply additional visual enhancements such as anti- aliasing, texture mapping, or transparency effects to improve the clarity of annotated points. The renderer may support multiple image formats including DICOM, TIFF, JPEG, and proprietary WSI formats. Image renderer 130 may utilize hardware acceleration through Graphic Processing Unit (GPU) 670 for computationally intensive rendering tasks, particularly when processing high-resolution WSIs with numerous annotations. The renderer may implement level-of-detail techniques to optimize performance by adjusting rendering quality based on current magnification levels, network bandwidth constraints, or available computational resources. Image renderer 130 may also incorporate caching mechanisms to store previously rendered portions of images to reduce redundant processing when a user navigates through different regions of the same image at similar magnification levels. The renderer may provide interfaces for customizing visualization parameters such as point size, opacity, or rendering priority based on annotation types or user preferences 110.

In addition to user commands and preferences entered through a user interface, the operation of image processor 115 may be controlled by external data, such as user preferences and/or lookup tables 110, depicted in FIG. 1. Details of such external data will be discussed in detail below.

Image processor 115 may include machine learning module 140. The machine learning module 140 may implement, generate, train or the like, one or more machine learning models. The one or more image processing machine-learning models may be trained based on training data that includes historical/genuine/prior patient tissue images and/or simulated/synthetic image data, historical/ground truth or simulated patient data, and/or the like. Synthetic image generation may use techniques described in U.S. App. No. 17/645,197, which is incorporated herein by reference. The training data may be used to train the image processing machine-learning models by modifying one or more weights, layers, synapses, biases, and/or the like of the image processing machine-learning models, in accordance with a machine-learning algorithm, as discussed herein. Alternatively, or in addition, such image data may be used to generate a three-dimensional image.

The image and annotated points, such as may be rendered by image processor 115, may be displayed to a user, such as on display 135, depicted in FIG. 1. Display 135 may include various display technologies, such as liquid crystal display (LCD), light-emitting diode (LED) display, organic light-emitting diode (OLED) display, virtual/augmented reality display, or other suitable display technology capable of presenting visual information with sufficient resolution to distinguish the annotated points and blended visualizations. In certain implementations, display 135 may be configured to support multiple color spaces, such as RGB, HSV, or CMYK, to accurately represent the visualizations determined by color blender 125. The display 135 may be calibrated to maintain color accuracy across different viewing conditions, which may be useful when visualizing subtle differences between annotation types in medical imaging applications. Display 135 may be integrated with user interface 120 to enable interactive viewing of the annotated images, allowing users to adjust magnification levels, select different portions of images, or modify visualization parameters. The display 135 may also include capabilities for presenting multiple images simultaneously or side-by-side comparisons of different visualization techniques applied to the same image data.

FIG. 2 depicts a flowchart of a method of improving visualization of processed images, according to one or more embodiments. As shown in FIG. 2, at operation 205, image processor 115 may receive annotated images. The annotated images may include, for example, pathology images including WSIs of a patient's anatomy. The WSIs may include annotations of points within each WSI. For example, the annotations may indicate information about a region of the WSI, tissue depicted in the WSI, a cell depicted in the WSI, or a tile of the WSI, a biomarker associated with the region of the WSI, etc. The indicated information may include, for example, a type of tissue depicted, such as cell/foreground or background, stromal tissue, epithelial tissue, lymphoid tissue, necrotic tissue, adipose tissue, connective tissue, vascular tissue, or other tissue types identifiable in pathology samples, a characterization of a cell, such as positive/negative, good/bad, cancer/benign, metastatic, pre-malignant, dysplastic, hyperplastic, atypical, inflammatory, reactive, degenerative, or other cellular classifications relevant to diagnostic assessment, attributes of a depicted cell or tissue such as, gene expressions, abnormalities, other morphologies including nuclear size variations, nuclear-to-cytoplasmic ratio, cellular organization patterns, infiltration patterns, architectural distortions, cellular differentiation levels, mitotic activity, chromatin patterns, nucleolar characteristics, membrane integrity, cytoplasmic features, intercellular spacing, and additional structural or functional characteristics that may be relevant for diagnostic, research, or analytical purposes. The annotations may include indications of how the annotated points should be displayed, such as particular colors, symbols, or patterns to be applied to the annotated points when displayed to a user.

At operation 210, image processor 115 may receive a selection of an image for display. The selection may be received from a user via a user interface such as user interface 120 depicted in FIG. 1 . The image processor 115 may process this selection to identify which of the available annotated images should be prepared for visualization. In some instances, a portion of an annotated image may be selected for display.

At operation 215, image processor 115 may receive a desired magnification level for displaying the selected image or a portion thereof. These parameters may be received from a user via a user interface such as user interface 120 depicted in FIG. 1. The magnification level may affect how the annotated points will be displayed, particularly whether individual points can be distinguished or whether blending techniques may be applied.

At operation 220, image processor 115 may determine a plurality of annotated points in the selected image or a portion thereof. This determination may involve identifying which annotations from the image data are present within the boundaries of the selected image or a portion thereof, and may include retrieving annotation metadata such as position coordinates, annotation types, and visualization parameters for each point.

At operation 225, image processor 115 may determine a default visualization for each annotated point of the selected image. The default visualization of each annotated point may be represented through various visual elements including colors, symbols, patterns, or shapes positioned at specific coordinates within the display image. These visual elements can vary in size, opacity, and border characteristics depending on the magnification level and display context. At higher magnification levels, individual points may be rendered with greater detail and distinct boundaries, while at lower magnification levels, the visual elements may adapt to maintain visibility. Users can interact with these annotated points through the user interface 120, which may allow for selection, filtering, or highlighting of specific annotation types. The system may adjust the visual prominence of annotations based on their relevance to current analysis tasks or user preferences stored in user preferences 110.

The process of determining specific colors, symbols, or patterns for annotated points may involve multiple approaches and considerations. Image processor 115 may apply default visualization attributes based on annotation content, metadata, or contextual information through several mechanisms. In one instance, a lookup table may map annotation categories to specific colors, symbols, or patterns, with distinct colors, symbols, or patterns assigned to different tissue types, cell classifications, or gene expressions.

Other algorithmic processes may generate default visualization schemes that may, for example, maximize contrast between different annotation types while maintaining perceptual coherence. Other algorithmic processes may generate visualization schemes that may, for example, maximize contrast between different annotation types while maintaining perceptual coherence. These algorithmic processes may implement color theory principles to select visualization parameters. The processes may utilize perceptual color spaces such as CIELAB or CIELUV to quantify color differences. The algorithms may analyze the distribution of annotation types within the image to determine appropriate color assignments. In some implementations, the algorithms may apply distance metrics in color space to ensure sufficient visual separation between annotation categories. The processes may incorporate feedback mechanisms that adjust color selections based on the specific image content and annotation density. The algorithm(s) may utilize adaptive thresholding techniques to determine optimal color boundaries between annotation types. The visualization schemes may incorporate luminance variations to enhance differentiation between similar hues. The algorithms may implement color harmony rules to create visually balanced representations across multiple annotation types. The processes may dynamically adjust saturation levels to emphasize important annotation categories while de-emphasizing others. The algorithm(s) may incorporate spatial context when determining visualization parameters, considering the proximity and clustering of different annotation types. The visualization schemes may include provisions for accommodating color vision deficiencies by selecting color combinations that remain distinguishable across various forms of color blindness.

Additionally, an artificial intelligence process may be used to determine a particular color, symbol, or pattern to be applied to each annotated point. The artificial intelligence process may implement neural networks trained on datasets of previously annotated images to identify visualization schemes for different annotation types. Machine learning models can analyze the spatial distribution of annotations and their semantic relationships to select colors that maximize visual distinction while maintaining contextual meaning. The system may utilize reinforcement learning techniques to refine visualization parameters based on user interactions with previously rendered images, adapting the color selection process to specific viewing contexts.

The process of determining a particular color, symbol, or pattern to be applied to each annotated point may take into account not only the information relating to the particular annotated point, but also other information about the image as a whole, the contents and visualizations of other annotated points, etc. For example, when multiple categories of annotation exist in an image, the system may use a color spectrum based on the number of categories, such that an image including annotated points of two types may visualize the two types of annotated points differently than if the image includes annotated points of three types. The visualization determination may also account for color theory principles to ensure that related annotation types receive visually related representations, while maintaining sufficient contrast between categories that require clear differentiation. For example, in a two-point-types case, the system may annotate a benign tumor in yellow, and a partially malignant tumor in red. In a three-point-type case, the system may annotate a benign tissue in yellow, a partially malignant tissue in dark orange, and a fully malignant tumor in red.

At operation 230, image processor 115 may determine a blended visualization for each pixel of the display image. That is, for each pixel of the display image, image processor 115 may determine what annotated points are present in that pixel, and the visualizations associated with each point. Image processor 115 may then determine a visualization for the portion of the image based on these visualizations. The portion of the display image may be, for example, a pixel, a tile, or any other appropriate portion of the image. For example, a pixel of the display image at low magnification may correspond to a region of the original image that includes multiple annotated points. Image processor 115 may determine a visualization for the pixel based on the annotations corresponding to the pixel and their associated visualizations. For example, if the visualizations associated with the annotations corresponding to the pixel are the same then the pixel may be assigned the same visualization. Similarly, if the visualizations associated with the annotations corresponding to the pixel include visualizations of a first type and visualizations of a second type, and the number or percentage of annotations with visualizations of the second type is below a threshold, then the pixel may be assigned the visualization of the first type. Alternatively, if the visualizations associated with the annotations corresponding to the pixel are not the same then the pixel may be assigned a blended visualization.

A blended visualization for of the display image or a portion thereof, such as, for example, a pixel, may be determined by a lookup table that may map specific combinations of annotation visualizations to predetermined blended outputs. In one embodiment, the lookup table may store predefined visualization values for various combinations of input annotation types, enabling efficient retrieval of appropriate blended visualizations without requiring real-time computation. For example, when annotations of two specific types correspond to a single pixel, the system may reference the lookup table to determine a predefined blended visualization that represents the combination of these annotation types. The lookup table approach may be particularly effective for applications with a finite set of annotation types and predictable visualization requirements.

In a different embodiment, the algorithmic blending may provide a computational approach to determining blended visualizations based on mathematical operations applied to the component visualizations. For example, if the visualizations are first and second RGB color codes, the blended visualization may be an averaging of each element of the first and second RGB color codes, or sub-portions thereof, to determine a blended RGB color code. Alternative algorithmic approaches may include weighted averaging based on annotation density or importance, maximum or minimum value selection for each color channel, or vector-based color space transformations. The blending may also involve coloring the annotation indicator according to portions of the sub-color codes, where a portion of the indicator is the first RGB color, and another portion of the indicator is the second RGB color, where the portions are determined by relative prevalence of the corresponding features corresponding to the annotations. In this technique, the colors might not be blended. The system may implement different algorithmic blending techniques depending on the visualization context, the types of annotations being combined, or the magnification level of the display.

In another embodiment, user-specified substitution may enable customization of blended visualizations based on user preferences or domain-specific requirements. The system may provide interfaces through which users can define rules for how specific combinations of annotations should be visualized when blended. These substitution rules may override default blending behaviors to emphasize particular annotation types, highlight specific combinations of annotations, or implement visualization schemes that align with established conventions in the field. User-specified substitutions may be stored as part of user preferences 110 and applied during the visualization process to ensure consistent representation of blended annotations across different viewing sessions.

In a further embodiment, artificial intelligence methods may determine blended visualizations through machine learning techniques that analyze patterns in annotation distributions and user interactions. These methods may employ neural networks trained on datasets of previously rendered images to identify effective blending strategies for different annotation combinations. The artificial intelligence approach may adapt blending parameters based on factors such as annotation density, spatial relationships between annotations, contextual information about the image content, or historical user preferences. Machine learning models may optimize blending visualizations to maximize information content while maintaining visual clarity, potentially improving the interpretability of complex annotation patterns at varying magnification levels.

As discussed above, a blended visualization may be a direct combination or averaging of two or more visualizations associated with the annotations corresponding to the portion of the display image. Alternatively, the blended visualization may be weighted based on the proportions of each of the visualizations. For example, if the visualizations are first and second RGB color codes, and the visualizations include 75% of the first RGB code and 25% of the second RGB code, the blended visualization may be a weighted averaging each element of the first and second RGB color codes comprising 75% of the first RGB code and 25% of the second RGB code.

The averaging operation is not limited to the RGB color space and can be performed in various other color spaces. In one implementation, the system may convert RGB point colors to HSV (Hue, Saturation, Value) color space, perform the averaging operation in HSV space, and then convert the blended values back to RGB for display. This approach may provide results that correspond more closely to human color perception, as HSV space may represent colors in a manner that more closely aligns with how humans perceive color relationships. For example, when blending yellow and blue annotations, averaging in RGB space may typically produce a gray result, while averaging in HSV space may produce a cyan-green result that can better represent the expected outcome of combining these colors. The blending algorithm may employ multiple color spaces depending on the visualization requirements to enhance the perceptual accuracy of the displayed image.

In addition, the blended visualization may be weighted based on the density of the visualizations associated with the annotations corresponding to the portion (pixel) of the display image. For example, a pixel corresponding to a region of the original image that includes a small number of annotations may have a blended visualization that is dimmer or less intense than a pixel corresponding to a region of the original image that includes a large number of annotations.

Although the discussion above is directed to blending two types of visualizations associated with the annotations corresponding to the portion of the display image, a blended visualization for a portion of the display image, such as, for example, a pixel, may be based on any number of such visualizations.

Within the regions of the display image, such as regions corresponding to first, second, or blended visualizations, there may be exceptional annotated points that a user wishes to remain visible, i.e., not blended to correspond to the visualization of the region. The determination of such an exceptional point may, for example, be based on a threshold number or percentage of annotated points with a visualization different from the visualization of the region. Such a threshold may be determined based on user preferences. Alternatively, an annotation for a point in the original image may include metadata marking the point as an exceptional point, such that it will always be displayed according to its visualization and not a visualization determined as discussed above. The displayed size of an exceptional point may be based on user preferences, such as, for example, a minimum height and width in pixels. Alternatively, the displayed size of an exceptional point may be set to a minimum size by system preferences or a default minimum size.

At operation 235 image processor 115 may provide (output) the display image to a user interface display, such as display 135 depicted in FIG. 1. The display image includes the determined blended visualizations for each pixel based on the annotated points and their corresponding distances. The user interface display presents the image with appropriate rendering of individual points or blended regions according to the magnification level selected by the user.

Any parameters controlling the operations of image processor 115 may be provided, for example, by way of user preferences, such as may be read from user preferences file 110 depicted in FIG. 1.

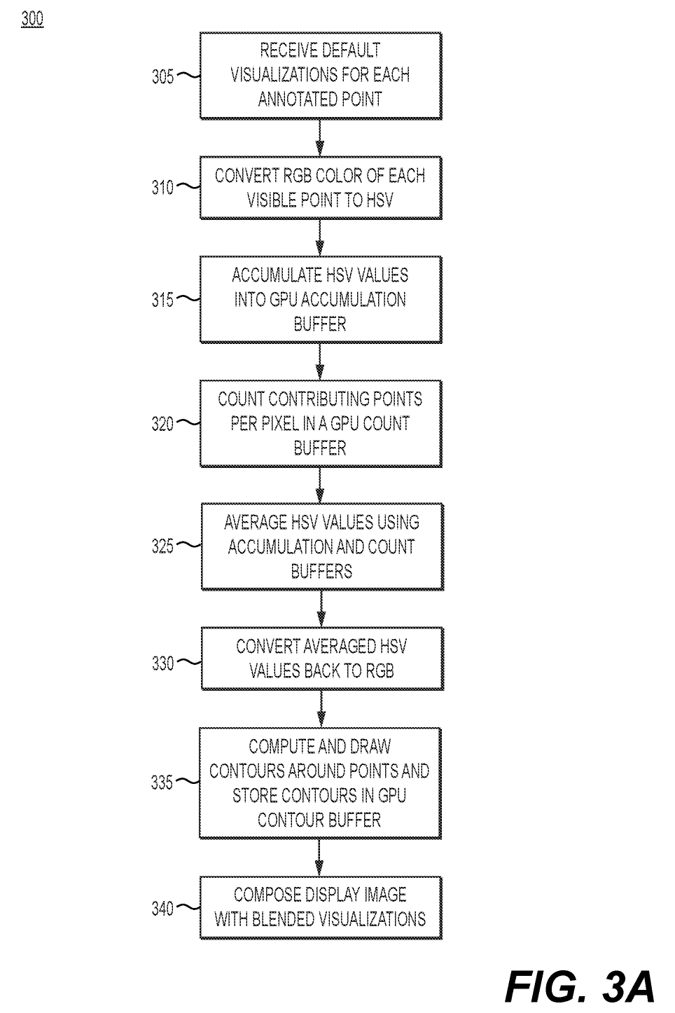

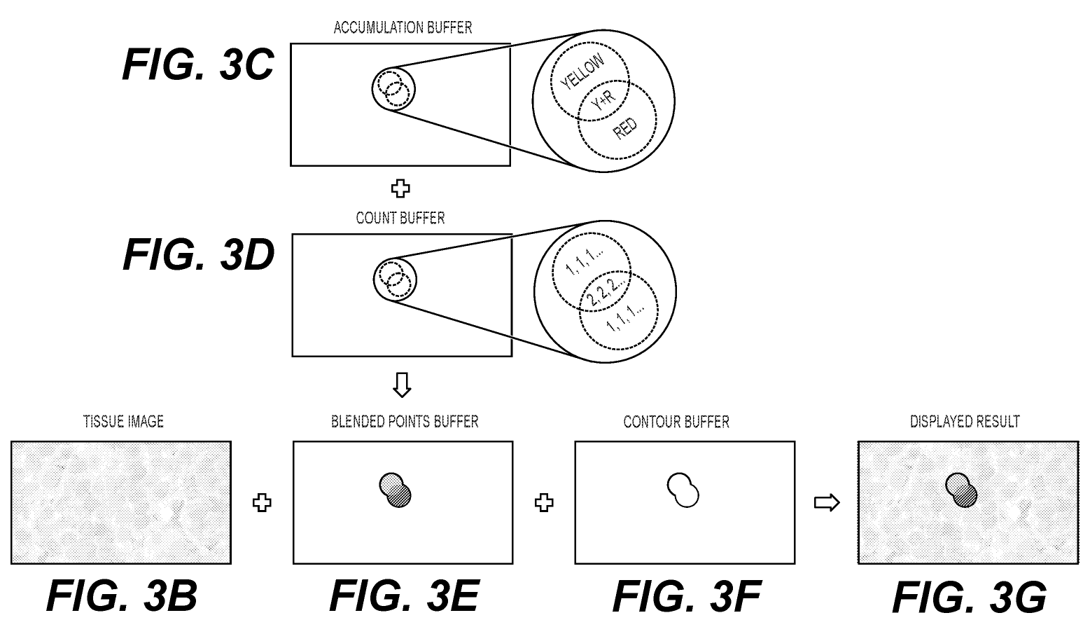

FIG. 3A depicts an exemplary process 300 that may be used for determining blended visualizations for annotated points in processed images. FIGS. 3B-3G depict corresponding visualizations at different stages of the blending process, illustrating an example transformation of raw annotation data into visually interpretable representations. Process 300 includes multiple steps that transform annotated point data into a blended visualization suitable for display at various magnification levels, ranging from high magnification where individual points may be discernible to low magnification where points may be densely clustered. In step 305, the image processing system may receive default visualization information for each annotated point in the selected image as may be determined in operation 225 in FIG. 2, as shown in FIG. 3B. This visualization information may include RGB color values, opacity settings, point sizes, and other visual attributes associated with each annotation type. The system may implement space partitioning techniques to identify points within the viewport. These techniques may include quadtrees, k-d trees, or R-trees for efficient spatial indexing of point data. The system may then proceed to step 310, where it may convert the RGB color values of each visible point to HSV (Hue, Saturation, Value) color space. This conversion may be performed using standard color

In step 305, the image processing system may receive default visualization information for each annotated point in the selected image as may be determined in operation 225 in FIG. 2, as shown in FIG. 3B. This visualization information may include RGB color values, opacity settings, point sizes, and other visual attributes associated with each annotation type. The system may implement space partitioning techniques to identify points within the viewport. These techniques may include quadtrees, k-d trees, or R-trees for efficient spatial indexing of point data. The system may then proceed to step 310, where it may convert the RGB color values of each visible point to HSV (Hue, Saturation, Value) color space. This conversion may be performed using standard color space transformation algorithms, which may involve mathematical operations to translate the RGB triplet (R,G,B) into corresponding HSV values (H,S,V). The HSV color space may provide advantages for blending operations as it separates color information (hue) from intensity (value) and purity (saturation), potentially enabling more perceptually accurate color mixing. In step 315, the system may accumulate the HSV values for each pixel associated with at least one point in a GPU accumulation buffer, as shown in FIG. 3C. The GPU accumulation buffer may store the aggregate color information (e.g. yellow, red, etc.) for each pixel location. This buffer may be implemented as a floating-point texture in GPU memory with dimensions corresponding to the output display resolution. Concurrently, in step 320, as shown in FIG. 3D, the image processing system may count contributing points per pixel in a separate GPU count buffer, which may track how many annotated points influence each pixel in the final visualization. This count buffer may be implemented as an integer texture in GPU memory with the same dimensions as the accumulation buffer.

In step 325, the image processing system may average the HSV values using the previously generated accumulation and count buffers from steps 315 and 320, respectively. This averaging operation may calculate representative color values for each pixel based on the contributing annotated points. The averaging may be performed by dividing the accumulated HSV values in the accumulation buffer by the corresponding count values in the count buffer for each pixel location. For pixels with zero counts, default background values may be assigned. The system may apply weighting factors during this averaging process based on point types, distances, or user-defined importance values to prioritize certain annotations in the blended result.

In step 330, the system may convert the averaged HSV values back to RGB color space for display compatibility. The conversion may preserve the perceptual characteristics achieved through HSV-space blending while returning to the standard RGB format used by display systems. This conversion may involve the inverse of the transformation applied in step 310, mapping each HSV triplet back to its corresponding RGB representation. The system may apply gamma correction or other color adjustments during this conversion to optimize the visual appearance on different display devices. They system may store the results of step 335 in a GPU blended points buffer. FIG. 3E shows the results from step 330, illustrating the distribution of point counts across the image, with brighter areas indicating higher point densities and darker areas representing regions with fewer annotated points.

Concurrently, the process continues with step 335, where the image processing system may compute and draw contours around points and store these contours in a GPU contour buffer as shown in FIG. 3F. The contour computation may distinguish the visual separation between regions with different annotation characteristics, which may improve the interpretability of the blended visualization. These contours may be generated using edge detection algorithms such as Sobel, Canny, or Laplacian operators applied to the count buffer or through density gradient analysis of the point distribution. The contours may be generated based on density gradients, annotation type boundaries, or other spatial characteristics of the annotated points. For example, a threshold-based approach may identify boundaries where the density of points changes by more than a predetermined percentage, or where the predominant annotation type shifts from one category to another. The GPU contour buffer may store these boundary (contour) definitions for incorporation into the final visualization. This buffer may be implemented as a single-channel texture in GPU memory, where non-zero values may indicate the presence of a contour at that pixel location. The contour information may be used in subsequent rendering steps to illustrate the visual distinction between different regions in the blended visualization.

Finally, in step 340, the system may compose the display image with the blended visualization as shown in FIG. 3G, integrating the processed color information with any additional visual elements required for the complete visualization. Step 340 may combine the blended points GPU buffer data from step 335, with the contour information (GPU contour buffer data) from step 335, and the tissue image illustrated in FIG. 3A, potentially applying transparency effects, highlighting, or other visual enhancements to improve the interpretability of the visualization. The system may overlay additional information such as scale bars, magnification indicators, or annotation legends to provide context for the visualization. The resulting display image may represent the annotated points with appropriate blending based on their spatial relationships and the current magnification level, enabling users to interpret the distribution and patterns of annotations across the image at multiple scales.

In an alternative embodiment, the image processing system may determine the distance between each annotated point of the plurality of annotated points in the selected image or a portion thereof. This determination involves calculating spatial relationships between annotated points using coordinate data associated with each point. The distance calculation may utilize various metrics such as Euclidean distance, Manhattan distance, or other appropriate distance measures depending on the image context and visualization requirements. For images with numerous annotated points, the system may implement spatial indexing techniques to optimize the distance calculation process. The determined distances may also serve as input parameters for subsequent visualization decisions, particularly when evaluating whether points should be rendered individually or as blended visualizations based on their proximity to each other. These distance calculations may be updated dynamically and continuously as users adjust magnification levels or navigate to different portions of the image.

Furthermore, the image processing system may determine that the distance between at least two points of the plurality of annotated points exceeds a predetermined threshold. This determination involves comparing the calculated spatial distances between annotated points in operation 230 of FIG. 2 with a threshold value that may be defined in system parameters, user preferences 110, or dynamically calculated based on the current magnification level. The threshold may serve as a decision boundary for when points should be rendered individually versus when they should be considered for blended visualization, as discussed below. When the distance between annotated points falls below this threshold, the system may interpret these points as being too close to be visually distinguished at the current magnification level, triggering the blending process. The threshold value may be adjusted based on factors such as display resolution, visualization density, annotation types, or visualization context to optimize the balance between detailed representation and visual clarity.

In some embodiments, the blended visualization may be based on the distance between each annotated point of the plurality of annotated points that exceed the predetermined threshold. The image processing system may calculate spatial relationships between annotated points and apply different blending weights or techniques depending on whether points are closely clustered or widely separated. For points with distances just above the predetermined threshold as determined in operation 235, image processor may apply gradual blending effects, while points with substantially greater distances may receive different visualization treatments. The distance-based blending approach can enhance the visual representation by preserving spatial context information even when individual points cannot be distinguished at lower magnification levels. This approach may incorporate distance metrics such as Euclidean distance, Manhattan distance, or other appropriate measures depending on the specific requirements of the visualization. The system may dynamically adjust the blending parameters as users navigate through different portions of the image or change magnification levels, ensuring that the visualization remains informative across various viewing contexts.

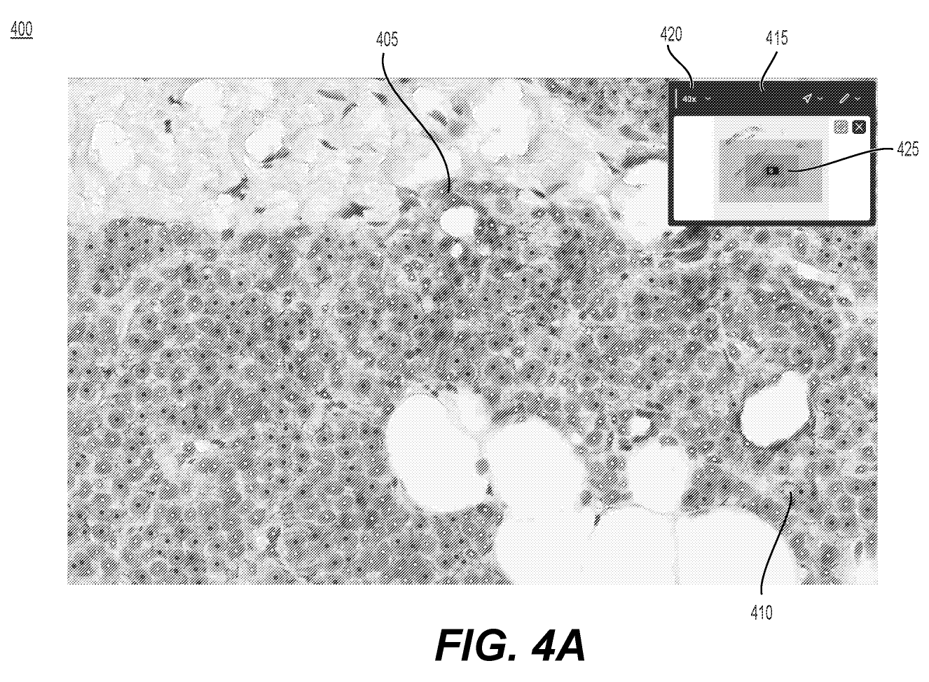

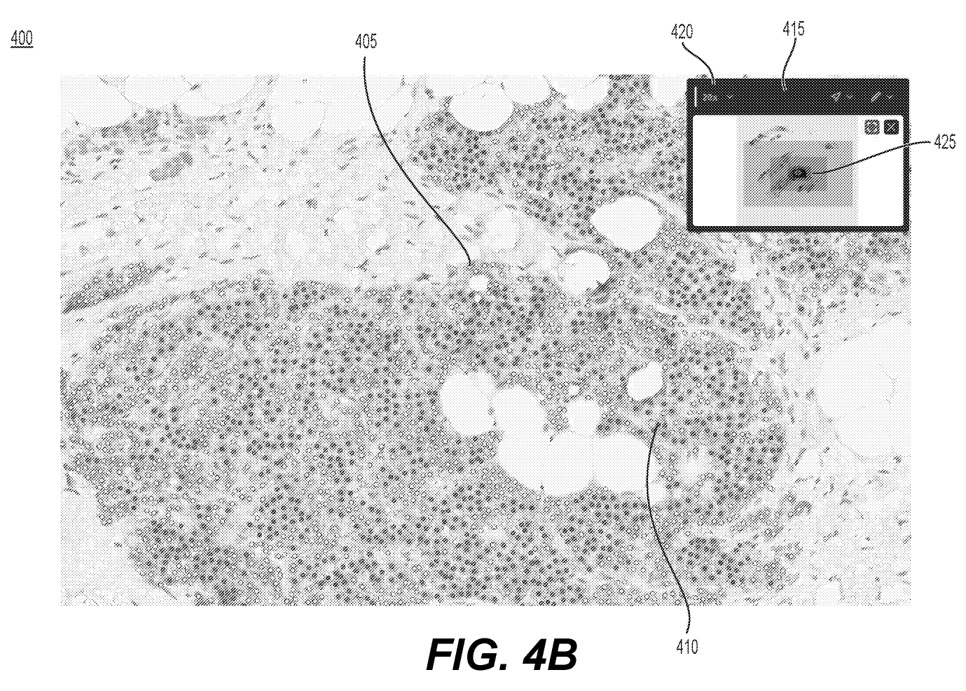

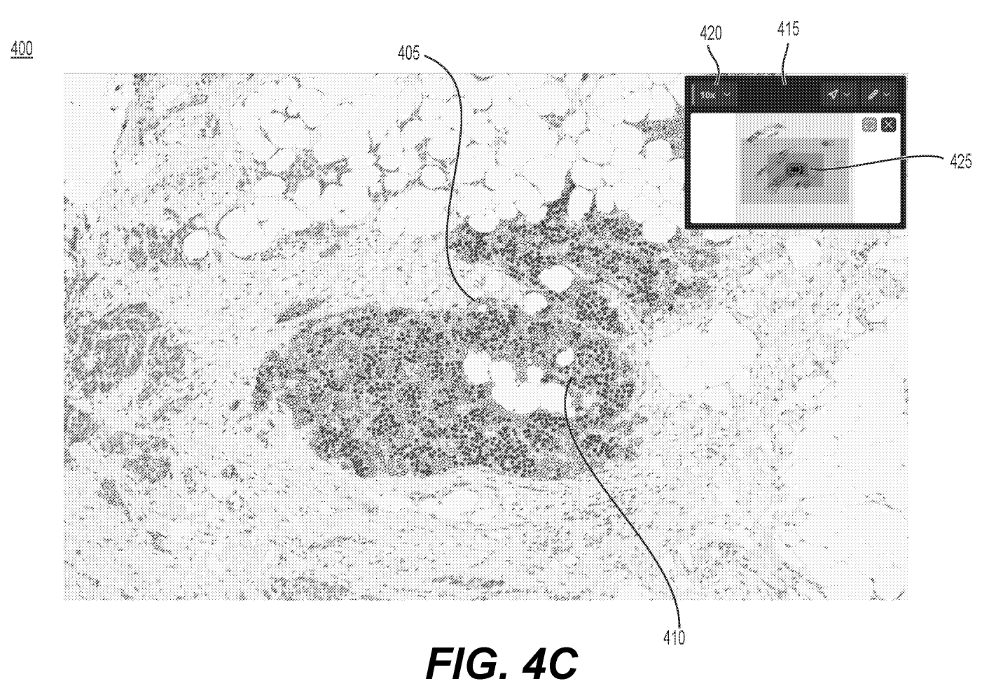

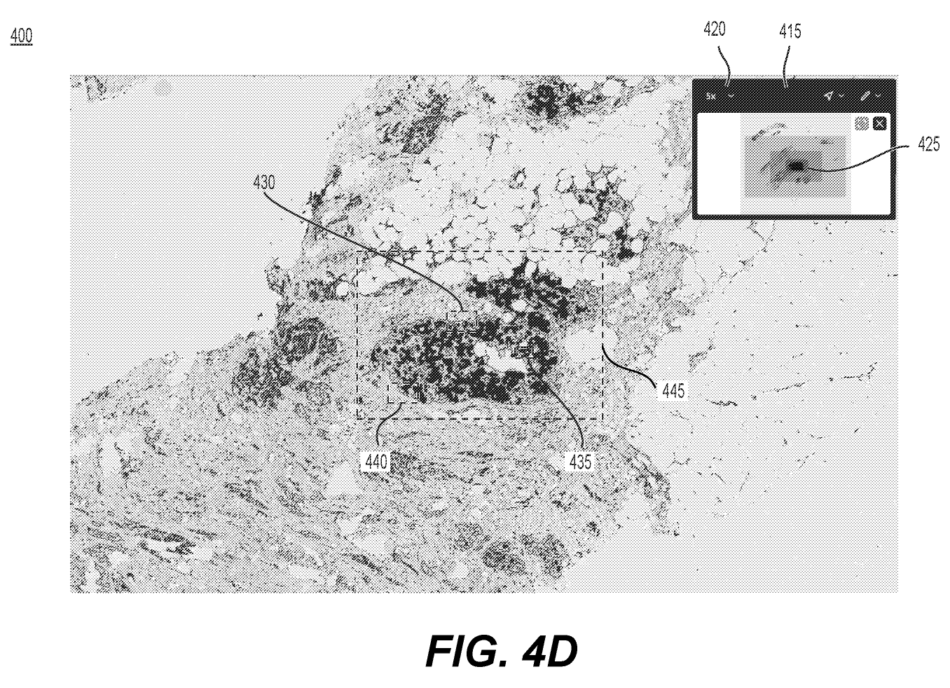

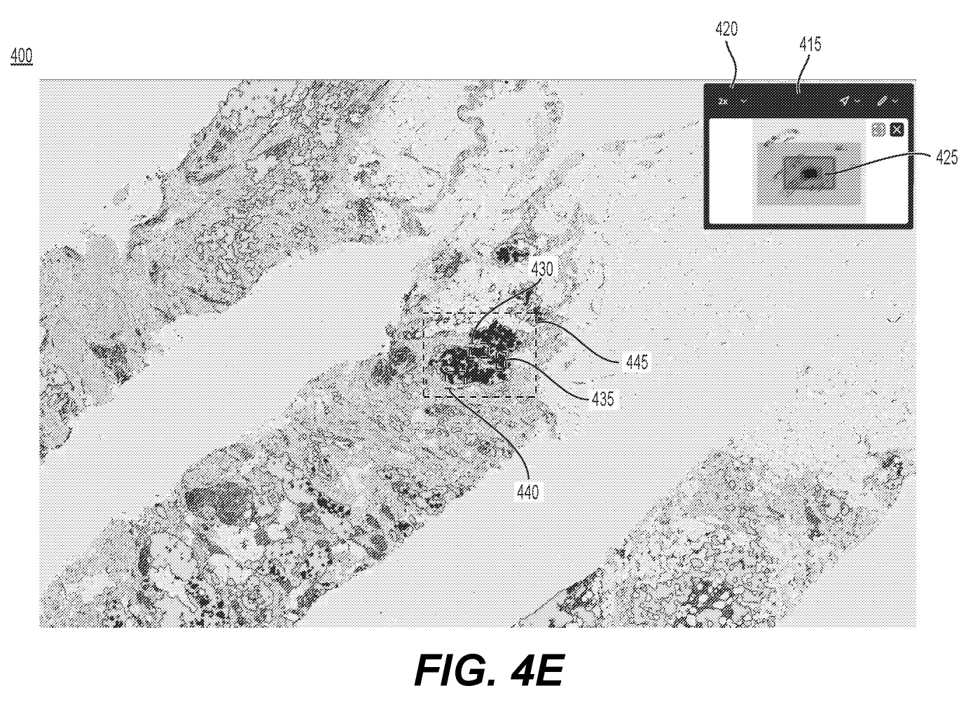

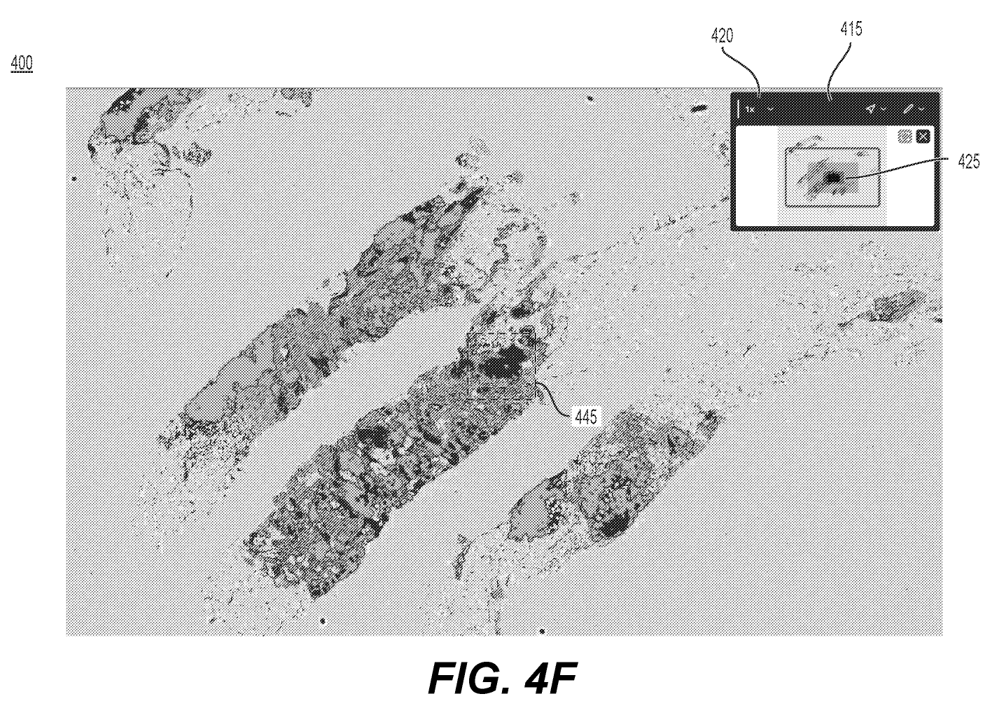

FIGS. 4A-4F depict exemplary image visualizations by a method of improving visualization of processed images, according to one or more embodiments. As shown in FIGS. 4A-4F, a user interface 400 for viewing annotated images, such as, for example, WSIs with labeled points, may include a visualization control 415 for controlling the display of the image. Visualization control 415 may include a magnification control 420 for controlling a level of magnification of the image, and view selector 425, for controlling which portion of an image is displayed.

FIGS. 4A-4C depict a pathology image viewed with high magnification level (40X, 20X, and 10X). At these high magnification levels, individual annotated points of the image may be discernable. For example, in FIGS. 4A-4C, individual annotated points of a first type 405 and a second type 410 may be seen individually. Furthermore, as the magnification decreases from FIG. 4A to FIG. 4B to 4C, the distance between two discernable annotated points decreases. At 40X magnification as shown in FIG. 4A, the system renders each annotated point with maximum detail, allowing users to distinguish specific cellular features and their corresponding annotations with high precision. The 20X magnification level in FIG. 4B maintains the visibility of individual points while providing a broader field of view, enabling users to observe patterns across multiple features while still discerning individual annotations. At 10X magnification in FIG. 4C, the system continues to render individual points, though the spatial density increases as more annotated points appear within the visualization area. The system maintains consistent color representation across these magnification levels to ensure annotation types remain identifiable despite the changing point density. The rendering algorithm adjusts point size proportionally to the magnification level to maintain visibility without introducing visual artifacts or distortions.

In FIG. 4D, a lower magnification level (5X) is shown via magnification control 420, such that a larger portion of the image is displayed, as indicated by view selector 425. At this lower magnification level, individual annotated points of the image may not be fully discerned. However, regions of the image may be displayed, such as a first region 430 including annotated points of a first type 405, a second region 435 including annotated points of a second type 410, and a blended region 440 including annotated points of the first and second type. The rendering and display of blended region 440 may be determined by any of the methods discussed above. At this lower 5X magnification level, or some other predetermined magnification level, the system may transition from individual point rendering to region-based visualization. The first region 430 displays a predominance of annotated points of a first type 405, represented by a visualization that corresponds to the original annotation color at higher magnifications. Similarly, second region 435 displays a predominance of annotated points of a second type 410 with its corresponding visualization. The system may apply any of the techniques described above to render these images. For example, the system may calculate the relative density of each annotation type within the pixel boundaries and may apply a weighted color blending function based on these densities. Furthermore, the blending algorithm may incorporate distance metrics between annotation points to determine the influence of each point on the final pixel color.

In FIGS. 4E-4F, a lower magnification level (2X, and 1X respectively) is shown via magnification control 420, such that a larger portion of the image is displayed, as indicated by view selector 425. As in FIG. 4D, individual annotated points of the image may not be discerned at this magnification level. The display of FIG. 4E shows a visualization area 445 containing first region 430 including annotated points of a first type 405, a second region 435 including annotated points of a second type 410, and blended region 440. In FIG. 4F, with 1X magnification, the system may combine the first region 430, second region 435, and blended region 440 into a larger visualization area that integrates the different annotation types. The visualization area 445 may display a macro-level representation where regional annotation patterns may become the focus.

At low magnification levels, the system may implement the blending techniques described above to provide visualization of the annotated points. The rendering of these regions may be controlled by user preferences or system settings that determine thresholds for blending, color selection, and visualization parameters. This approach may enable users to maintain contextual understanding of annotation distributions across larger portions of the image while preserving the ability to distinguish between different annotation regions, even at lower magnification levels where individual points cannot be separately visualized. Furthermore, users may be able to observe global patterns in annotation distribution that might not be apparent when viewing smaller sections at higher magnification levels.

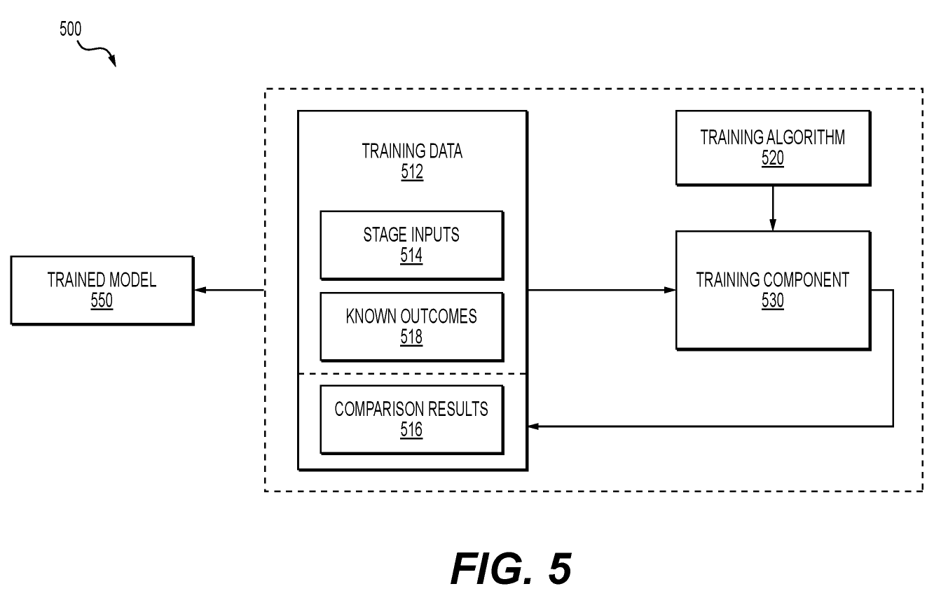

FIG. 5 depicts a flow diagram for training a machine-learning model. As shown in flow diagram 500 of FIG. 5, training data 512 may include one or more of stage inputs 514 and known outcomes 518 related to a machine-learning model to be trained. The stage inputs 514 may be from any applicable source including a component or set shown in the figures provided herein. The known outcomes 518 may be included for machine-learning models generated based on supervised or semi- supervised training. An unsupervised machine-learning model might not be trained using known outcomes 518. Known outcomes 518 may include known or desired outputs for future inputs similar to or in the same category as stage inputs 514 that do not have corresponding known outputs.

The training data 512 and a training algorithm 520 may be provided to a training component 530 that may apply the training data 512 to the training algorithm 520 to generate a trained machine-learning model 550. According to an implementation, the training component 530 may be provided comparison results 516 that compare a previous output of the corresponding machine-learning model to apply the previous result to re-train the machine-learning model. The comparison results 516 may be used by the training component 530 to update the corresponding machine-learning model. The training algorithm 520 may utilize machine-learning networks and/or models including, but not limited to a deep learning network such as Graph Neural Networks (GNN), Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 500 may be a trained machine-learning model 550

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously be updated based on feedback associated with use or implementation of the machine-learning model outputs.

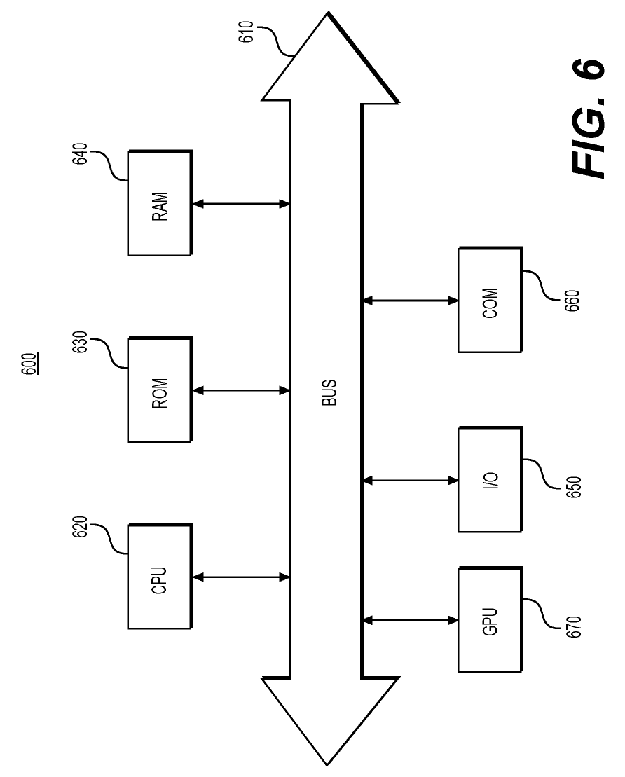

FIG. 6 depicts a high-level functional block diagram of an exemplary computer device or system, in which embodiments of the present disclosure, or portions thereof, may be implemented, e.g., as computer-readable code. Additionally, each of the exemplary computer servers, databases, user interfaces, modules, and methods described above with respect to FIGS. 1-5 can be implemented in device 600 using hardware, software, firmware, tangible computer readable media having instructions stored thereon, or a combination thereof and may be implemented in one or more computer systems or other processing systems. Hardware, software, or any combination of such may implement each of the exemplary systems, user interfaces, and methods described above with respect to FIGS. 1-5.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor or a plurality of processors, or combinations thereof. Processor devices may have one or more processor "cores."

Various embodiments of the present disclosure, as described above in the examples of FIGS. 1-5, may be implemented using device 600. After reading this description, it will become apparent to a person skilled in the relevant art how to implement embodiments of the present disclosure using other computer systems and/or computer architectures. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 6, device 600 may include a central processing unit (CPU) 620. CPU 620 may be any type of processor device including, for example, any type of special purpose or a general-purpose microprocessor device. As will be appreciated by persons skilled in the relevant art, CPU 620 also may be a single processor in a multi- core/multiprocessor system, such system operating alone, or in a cluster of computing devices operating in a cluster or server farm. CPU 620 may be connected to a data communication infrastructure 610, for example, a bus, message queue, network, or multi-core message-passing scheme.

Device 600 also may include a main memory 640, for example, random access memory (RAM), and also may include a secondary memory 630. Secondary memory 630, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 630 may include other similar means for allowing computer programs or other instructions to be loaded into device 600. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 600.

Device 600 also may include a communications interface ("COM") 660. Communications interface 660 allows software and data to be transferred between device 600 and external devices. Communications interface 660 may include a modem, a network interface (such as an Ethernet card), a communications port, a PCMCIA slot and card, or the like. Software and data transferred via communications interface 660 may be in the form of signals, which may be electronic, electromagnetic, optical, or other signals capable of being received by communications interface 660. These signals may be provided to communications interface 660 via a communications path of device 600, which may be implemented using, for example, wire or cable, fiber optics, a phone line, a cellular phone link, an RF link or other communications channels. Device 600 also may include a graphics processing unit (GPU) 670. GPU 670 may be any type of graphics processor device including, for example, any type of special purpose or a general-purpose microprocessor device configured for rendering graphical information, such as the point visualizations discussed above. The hardware elements, operating systems and programming languages of such equipment are conventional in nature, and it is presumed that those skilled in the art are adequately familiar therewith. Device 600 also may include input and output

Device 600 also may include a graphics processing unit (GPU) 670. GPU 670 may be any type of graphics processor device including, for example, any type of special purpose or a general-purpose microprocessor device configured for rendering graphical information, such as the point visualizations discussed above.

The hardware elements, operating systems and programming languages of such equipment are conventional in nature, and it is presumed that those skilled in the art are adequately familiar therewith. Device 600 also may include input and output ports 650 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. The methods of this disclosure, however, are not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for improving visualization of processed images, the method comprising:
determining a plurality of annotated points associated with a selected image;
determining a default visualization of each annotated point of the plurality of annotated points in the selected image;
determining a display image by determining a blended visualization for each pixel of the display image based on the plurality of annotated points of the selected image corresponding to the pixel; and
outputting the determined display image.

2. The computer-implemented method of claim 1, wherein the blended visualization is determined by steps comprising:
averaging the default visualizations of each annotated point of the plurality of annotated points corresponding to each pixel in the selected image; and
computing and drawing contours around the default visualizations of the plurality of annotated points.

3. The computer-implemented method of claim 1, wherein the selected image is a whole slide image (WSI), and wherein each annotated point among the plurality of annotated points comprises information about a region of the WSI, tissue depicted in the WSI, a cell depicted in the WSI, or a tile of the WSI.

4. The computer-implemented method of claim 3, wherein information of the annotated point comprises one or more of a type of tissue depicted, the type of tissue being one of cell tissue, foreground tissue, or background tissue, a characterization of a cell, the characterization being one or more of positive, negative, good, bad, cancer, or benign, or an attribute of tissue depicted, the attribute being one or more of a gene expression, an abnormality, or a morphology.

5. The computer-implemented method of claim 1, wherein the default visualization associated with the plurality of annotated points are determined by a look up table, an algorithmic process, or an artificial intelligence system.

6. The computer-implemented method of claim 1,
wherein the default visualizations associated with the plurality of annotated points corresponding to the pixel include visualizations of a first type and visualizations of a second type, and wherein the blended visualization of each pixel of the display image is determined based on a number or a percentage of annotations with visualizations of the second type being below a threshold.

7. The computer-implemented method of claim 1, wherein the blended visualization of each pixel of the display image is determined by a lookup table, an algorithmic blending, or a user-specified substitution.

8. The computer-implemented method of claim 1,
wherein the default visualizations associated with the plurality of annotated points corresponding to the pixel include visualizations of a first type and visualizations of a second type, and wherein the blended visualization of each pixel of the display image is weighted based on a proportion of the visualizations of the first type and the visualizations of the second type.

9. The computer-implemented method of claim 1,
wherein the blended visualization of each pixel of the display image is weighted based on a density of the default visualizations associated with the plurality of annotated points corresponding to the pixel.

10. The computer-implemented method of claim 1, wherein the default visualizations associated with the plurality of annotated points corresponding to the pixel include visualizations of a first type, visualizations of a second type, and visualizations of a third type.

11. A system for improving visualization of processed images, the system comprising:
a data storage device storing instructions for improving visualization of processed images in an electronic storage medium; and
a processor configured to execute the instructions to perform operations comprising:
determining a plurality of annotated points associated with a selected image;
determining a default visualization of each annotated point of the plurality of annotated points in the selected image;
determining a display image by: determining a blended visualization for each pixel of the display image based on the plurality of annotated points of the selected image corresponding to the pixel; and outputting the determined display image.

12. The system of claim 11, wherein the blended visualization is determined by steps comprising:
averaging the default visualizations of each annotated point of the plurality of annotated points corresponding to each pixel in the selected image; and
computing and drawing contours around the default visualizations of the plurality of annotated points.

13. The system of claim 11, wherein the default visualizations associated with the plurality of annotated points corresponding to the pixel include visualizations of a first type and visualizations of a second type, and wherein the blended visualization of each pixel of the display image is determined based on a number or a percentage of annotations with visualizations of the second type being below a threshold.

14. The system of claim 11, wherein the blended visualization of each pixel of the display image is determined by a lookup table, an algorithmic blending, or a user-specified substitution.

15. The system of claim 11, wherein the blended visualization of each pixel of the display image is weighted based on a density of the visualizations associated with the annotations corresponding to the pixel.

16. A non-transitory machine-readable medium storing instructions that, when executed by a computing system, causes the computing system to perform operations for improving visualization of processed images, the operations comprising:
determining a plurality of annotated points associated with a selected image;
determining a default visualization of each annotated point of the plurality of annotated points in the selected image;
determining a display image by determining a blended visualization for each pixel of the display image based on the plurality of annotated points of the selected image corresponding to the pixel; and
outputting the determined display image.

17. The non-transitory machine-readable medium of claim 16, wherein the blended visualization is determined by steps comprising:
averaging the default visualizations of each annotated point of the plurality of annotated points corresponding to each pixel in the selected image; and
computing and drawing contours around the default visualizations of the plurality of annotated points.

18. The non-transitory machine-readable medium of claim 16, wherein the default visualizations associated with the plurality of annotated points corresponding to the pixel include visualizations of a first type and visualizations of a second type, and wherein the blended visualization of each pixel of the display image is determined based on a number or a percentage of annotations with visualizations of the second type being below a threshold.

19. The non-transitory machine-readable medium of claim 16, wherein the blended visualization of each pixel of the display image is determined by a lookup table, an algorithmic blending, or a user-specified substitution.

20. The non-transitory machine-readable medium of claim 16, wherein the blended visualization of each pixel of the display image is weighted based on a density of the visualizations associated with the annotations corresponding to the pixel.
